(19) United States
(12) Patent Application Publication
(10) Pub. No.: US 2022/0040703 A1
(43) Pub. Date: Feb. 10, 2022

(54) IMPACT CRUSHER

(71) Applicant: TEREX GB LIMITED, Leicestershire (GB)

(72) Inventor: Ian BOAST, Leicestershire (GB)

(73) Assignee: TEREX GB LIMITED, Leicestershire (GB)

(21) Appl. No.: 17/297,725

(22) PCT Filed: Nov. 27, 2019
(86) PCT No.: PCT/GB2019/053347

§ 371 Date: May 27, 2021

(30) Foreign Application Priority Data
Nov. 28, 2018 (GB) 1819339.1

(51) Int. Cl. B02C 13/09; B02C 13/30

(52) U.S. Cl. CPC B02C 13/095; B02C 13/30

(57) ABSTRACT

An impact crusher is provided which comprises a frame defining a crushing chamber, a rotor provided with at least one hammer, at least one impact apron plate, and a rotor positioning device configured to adjust a rotational position of the rotor. The rotor positioning device comprises a piston motor coupled to the rotor and having a cylinder block comprising a plurality of cylinders; a plurality of pistons, a respective piston being slidably mounted in a respective cylinder; and a surface against which the pistons are configured to exert a force. The cylinder block and the surface are arranged for relative rotation, and the cylinder block or the surface is operatively coupled to the rotor, such that relative rotation of the cylinder block and the surface causes rotation of the rotor. The rotor positioning device is operable in first and second modes.

### FIELD OF THE INVENTION

The present invention relates to an impact crusher and a rotor positioning device for an impact crusher, more particularly, but not exclusively to an impact crusher for crushing rock material.

### BACKGROUND OF THE INVENTION

Quarried material is often processed, by means of a crushing plant, for the production of aggregate, for example. There are various known forms of crushing plant for the comminution of rock material and the like, once of which is referred to as an impact crusher or a horizontal shaft impact crusher.

One known impact crusher comprises a frame defining a crushing chamber, a rotor having a series of hammers and at least one impact apron plate mounted on the frame. In use, material to be crushed is introduced into the crushing chamber. The rotor rotates causing the hammers to strike the material against the apron impact plate, thereby breaking up the material. The relative spacing between the hammers and the impact apron plate determines the dimension of the crushed material produced by the impact crusher. Once the material is sufficiently small, the material will leave the crushing chamber through the space defined between the hammers and the impact apron plate.

As will be appreciated, the hammers can be exposed to considerable wear and therefore will require regular maintenance or replacement. Typically, this requires positioning of the hammer in a particular rotational position relative to the rotor, such that the hammer can be accessed.

In addition, the spacing between the hammer and the impact apron plate will require calibration to ensure material of a desired dimension is produced by the impact crusher. To set this spacing, rotational adjustment of the hammer position will again be required.

In some impact crushers, the rotational position of the hammers is adjusted manually by an operator. Typically, this requires the operator to insert his/her arm through an inspection hatch to rotate the rotor and therefore rotate the position of the hammers. It will be clear that this presents significant health and safety risks to operators.

US2013/0284839 discloses an impact mill having a rotor positioning device that includes indexing elements for positioning the end of one of the hammers as close as possible to the impact screen for adjusting the spacing therebetween. It also includes a geared motor driving a pinion capable of engaging with a toothed wheel rotationally fixed to the rotor so as to rotate the rotor from a rest state until one of the hammers is as close as possible to the screen. It will be appreciated that engagement of the pinion and the toothed wheel while the impact mill is in normal use will cause considerable wear of the geared motor. Alternatively, the pinion is moved out of engagement with the toothed wheel when normal operation of the impact mill is required in order to protect the geared motor. This is clearly a cumbersome device which requires the geared motor and pinion to be physically engaged with the toothed wheel when rotation of the rotor to a desired position is required, and disengaged from the pinion when ordinary operation is required.

WO2016/074712 discloses a rotor positioning device for a horizontal shaft impact crusher configured to adjust a rotational position of a rotor of the impact crusher. The device is mountable to an external region of a main frame of a crusher so as to releasably couple to an exposed end of a main shaft of the rotor. The device comprises a shaft engager capable of being moved to and from engaging contact with the rotor shaft end. A drive component provides rotational drive of a rod to impart rotational adjustment of the position of the rotor shaft. This also requires the rotor positioning device to be moved to and from engaging contact with the rotor shaft end of the impact crusher. In this arrangement, personnel are required to move the shaft engager of the rotor positioning device into and out of engagement with the impactor as and when rotation by the rotor positioning device and normal use of the impact crusher are required. This is clearly time consuming and places additional demands on operator personnel. An additional problem is that it can be difficult to align the shaft engager with the rotor shaft end without manual intervention. It will be appreciated that these will often be out of alignment when the rotor comes to rest and require an operator to ensure correct alignment.

The present disclosure seeks to overcome or at least mitigate/alleviate one or more problems associated with the prior art.

### SUMMARY OF THE INVENTION

According to a first aspect of the present disclosure, an impact crusher is provided, comprising a frame defining a crushing chamber, a rotor provided with at least one hammer, at least one impact apron plate, and a rotor positioning device configured to adjust a rotational position of the rotor, wherein the rotor positioning device comprises a piston motor coupled to the rotor and having:
a cylinder block comprising a plurality of cylinders;
a plurality of pistons, a respective piston being slidably mounted in a respective cylinder; and
a surface against which the pistons are configured to exert a force;

wherein the cylinder block and the surface are arranged for relative rotation, and wherein the cylinder block or the surface is operatively coupled to the rotor, such that relative rotation of the cylinder block and the surface causes rotation of the rotor; the rotor positioning device being operable in two modes, wherein:
in the first mode, the piston motor is configured to actuate the pistons in a predetermined sequence such that the pistons cooperate with the surface to generate torque, thereby causing relative rotation of the cylinder block and the surface, causing rotation of the rotor, and
in the second mode, the piston motor is configured to arrange the pistons and/or the surface such that free rotation of the rotor is permitted.

In other words, an impact crusher is provided having a rotor positioning device configured to adjust the rotational position of the rotor. As will be understood by those skilled in the art, the at least one hammer becomes worn in use and so will require maintenance and/or replacement. This requires rotational adjustment of the rotor to position the hammer in the desired position for repair or replacement.

In addition, it is often desirable to set a crush size by adjusting the spacing between the hammer and the apron plate. Again, this requires adjustment of the rotational position of the hammer.

The provision of a rotor positioning device is therefore advantageous in carrying out these activities.

Further, the rotor positioning device comprises a piston motor coupled to the rotor, the rotor positioning device being operable in two modes. In the first mode, the piston motor is configured to actuate the pistons in a predetermined sequence to exert force against the surface. The pistons and the surface are configured such that they cooperate to generate torque and therefore cause relative rotation of the cylinder block and the surface, which results in rotation of the rotor. In this mode of operation, actuation of the pistons may cause rotation of the rotor, and therefore adjustment of the rotational position of the hammer. This is advantageous when maintenance of the hammer(s) is required or when adjustment of the crush size is required.

In the second mode, the piston motor is configured to arrange the pistons and/or the surface such that they do not cooperate to generate torque. Accordingly, relative rotation of the cylinder block and the surface is not generated. In this mode, free rotation of the rotor (i.e. of the cylinder block relative to the surface) is permitted e.g. in normal operation of the impact crusher. The pistons and/or the surface are arranged such that free rotation of the rotor is not prevented.

It will be appreciated that the rotor positioning device can be configured to rotate the position of the rotor, for example, when maintenance of the hammer(s) is required or when adjustment of the crush size is required. It can also be configured to permit free rotation of the rotor, for example, during normal use of the impact crusher (i.e. the second mode of operation).

Decoupling of the piston motor from the rotor is not required. In normal use of the impact crusher, the piston motor may operate in the second mode, thereby permitting free rotation of the rotor. When adjustment of the rotational position of the hammer(s) is required, the piston motor may operate in the first mode to cause rotation of the rotor. This enables the motor to be permanently secured to the impact crusher rotor.

The rotor positioning device is configured to selectively rotate the rotor and permit free rotation of the rotor. Therefore a means for positioning the rotor is provided which does not require the rotor positioning device itself to be engaged to and disengaged from the impact crusher rotor. Rather, the rotor positioning device is configured such that the piston motor may be switched between a first and second mode. This is advantageous since personnel are not required to move the rotor positioning device into and out of engagement with the impact crusher shaft.

In exemplary embodiments, the impact crusher comprises a drive motor, separate from the piston motor, arranged to drive the rotor when the impact crusher is in use.

In other words, the impact crusher is driven by a drive motor which is separate from the piston motor of the rotor positioning device. The drive motor is arranged to drive the rotor of the impact crusher when in use. In this way, the piston motor of the rotor positioning device can be thought of as an auxiliary motor and can be a different type of motor to the main drive motor. This allows the drive motor to be selected to optimise efficiency and the separate piston motor of the rotor positioning device to be optimised for operating in the first and second modes i.e. for rotating the impact crusher rotor and permitting free rotation of the rotor as desired.

For example, the drive motor may be a high speed drive, such as a diesel or electric motor, which is optimal for efficiency. Due to the high speeds of these drives, it may be difficult to position the rotor accurately using these drives. In the case of a separate piston motor of the rotor positioning device, the drive motor is not required to accurately position the rotor during maintenance, for example.

The piston motor of the rotor positioning device may be a hydraulic motor, which is optimal for permitting safe positioning during maintenance. Such motors are typically less efficient than diesel or electric motors when used to drive the rotor. In the case of a separate piston motor of the rotor positioning device, the efficiency of the piston motor is not a priority.

In exemplary embodiments, the impact crusher comprises a cavity defined between the surface and an outer surface of the cylinder block and pistons disposed therein, wherein in the second mode of operation, the piston motor is configured to pressurise the cavity, thereby applying pressure to the pistons in a direction towards the respective cylinder, e.g. to retract the piston from the surface.

In some embodiments, the piston motor comprises at least one resilient member configured to bias the pistons into their respective cylinder, hence away from the surface.

In this way, all of the pistons are retracted into their respective cylinder when the cavity is pressurised. In some embodiments, this ensures that the pistons are disengaged from the surface.

In exemplary embodiments, the cylinder block is operatively coupled to the rotor, such that rotation of the cylinder block causes rotation of the rotor.

In some embodiments, the cylinder block is directly coupled to the rotor.

In exemplary embodiments, a component comprising the surface is operatively coupled to the rotor, such that rotation of the component comprising the surface causes rotation of the rotor.

In some embodiments, the component comprising the surface is directly coupled to the rotor.

In exemplary embodiments, in the second mode of operation, the piston motor is configured to retract the plurality of pistons away from the surface such that the plurality of pistons disengage the surface.

In other words, in the second mode of operation the plurality of pistons do not exert a force against the surface but are retracted to permit free rotation of the rotor. This reduces the number of touching parts during normal operation of the impact crusher, thereby reducing wear on the rotor positioning device.

In exemplary embodiments, the piston motor comprises a radial piston motor in which the cylinders are radially disposed in the cylinder block, with respect to an axis of rotation of the rotor.

In other words, a longitudinal axis of each cylinder extends in a radial direction with respect to the axis of rotation. Put another way, the cylinders extend in a direction substantially perpendicular to the axis of rotation.

In exemplary embodiments the radial piston motor comprises a cam ring, wherein the surface comprises a cam surface of the cam ring, the cam surface comprising a plurality of lobes, each lobe having a rising ramp and a falling ramp.

The cam surface of the cam ring may be an internal surface. In such embodiments, the cam ring is arranged to encircle the cylinder block and the pistons are configured to act radially outwards to engage the surface. Alternatively the cam surface may be an external surface of the cam ring. In such embodiments, the cylinder block is arranged to encircle the cam surface of the cam ring such that the pistons act radially inwards to engage the cam surface.

In exemplary embodiments, the pistons comprise cam follower rollers, having an outer surface which rolls against the cam surface of the cam ring.

In this way, wear between the pistons and the cam surface is reduced.

In exemplary embodiments, the cam ring is coaxial with the axis of rotation.

In exemplary embodiments, the piston motor comprises an axial piston motor, in which the cylinders extend in a direction substantially parallel to an axis of rotation of the rotor.

In exemplary embodiments, the axial piston motor comprises a swash plate, wherein the surface comprises a planar surface of the swash plate.

In exemplary embodiments, the planar surface of the swash plate is provided transverse to the axis of rotation of the rotor, wherein the angle of the planar surface to the axis of rotation is variable.

In some embodiments, when the motor is configured to operate in the second mode, the planar surface of the swash plate is positioned perpendicular to the axis of rotation of the rotor to enable free rotation of the rotor. In some embodiments, when the motor is configured to operate in the first mode, the planar surface of the swash plate is at an angle i.e. not perpendicular, to the axis of rotation of the rotor. In this way, the pistons of the axial piston motor may be actuated to exert a force against the angled planar surface, thereby causing relative rotation of the planar surface and the cylinder block. Since the angle of the planar surface to the axis of rotation is variable, the axial piston motor can be switched between the first mode of operation and the second mode of operation, without requiring decoupling of the rotor positioning device from the impact crusher rotor.

In exemplary embodiments, the angle of the planar surface of the swash plate to the axis of rotation of the rotor is variable between 45 and 135° to the axis of rotation.

In other words, in embodiments wherein the axis of rotation is substantially horizontal, the planar surface of the swash plate is variable between ±45° to the vertical.

In exemplary embodiments, each piston is provided at one end with a slider shoe, wherein the slider shoes are configured to slide across the surface of the swash plate.

In the first mode of operation, the slider shoes may be configured to bear against the surface of the swash plate.

In this way, wear between the pistons and the swash plate is reduced.

In exemplary embodiments, the piston motor is a hydraulic piston motor and comprises a plurality of conduits for passing hydraulic fluid into the respective cylinders for actuation of the respective pistons.

In exemplary embodiments, the piston motor is operable in three modes, wherein in the third mode, the piston motor is configured to actuate at least one of the pistons to exert force against the surface, such that relative rotation of the cylinder block and the surface is inhibited, thereby inhibiting rotation of the rotor.

In this way, in the third mode of operation, the piston motor is configured to act as a brake, locking relative rotation of the surface and the cylinder block and therefore preventing rotation of the impact crusher rotor.

In exemplary embodiments the rotor positioning device further comprises a brake configured to lock the surface and cylinder block against relative rotation, hence preventing rotation of the rotor, e.g. in the event of hydraulic fluid leakage.

In some embodiments, the brake is released during normal operation of the impact crusher and/or rotation of the impact crusher rotor by the rotor positioning device.

In exemplary embodiments, in the first mode of operation, actuation of the pistons in the predetermined sequence comprises actuating sets of pistons in a predetermined order and/or at a predetermined relative timing, wherein each set comprises one or more pistons.

In some embodiments, the set of pistons comprises 2, 3, 4, 5, 6, 7, 8, 9 or 10 pistons. In some embodiments each set comprises more than 10 pistons. In some embodiments, the sets may comprise different numbers of pistons.

In exemplary embodiments, the piston motor comprises a mechanical timing mechanism configured to actuate the pistons in the predetermined sequence when the motor is operating in the first mode.

In this way, a simple timing mechanism for actuating the pistons is provided.

In exemplary embodiments, the or an axis of rotation of the rotor is coaxial with an axis of rotation of the cylinder block and/or an axis of rotation of the surface.

In exemplary embodiments, the piston motor comprises a housing and the impact crusher comprises a torque arm coupled to the piston motor housing to inhibit relative rotation between the piston motor housing and the impact crusher frame.

In some embodiments, the torque arm is arranged to couple the piston motor housing to the impact crusher frame to inhibit relative rotation therebetween.

In some embodiments, the torque arm is arranged to couple the piston motor housing to a fixed position with respect to the impact crusher frame to inhibit relative rotation between the piston motor housing and the impact crusher frame.

In exemplary embodiments, the piston motor comprises a motor shaft coupled to the cylinder block or the surface, and wherein the motor shaft is coupled to the rotor for rotation.

In some embodiments the motor shaft is directly coupled to the rotor of the impact crusher.

In exemplary embodiments, the piston motor comprises bearings arranged to support the motor shaft.

In this way, at a first end of the rotor, coupled to the motor shaft, the rotor is supported by the piston motor bearings, and a second end of the rotor, distal the piston motor, is supported by a separate set of bearings.

In other words, rather than having a set of bearings at each end of the impact crusher rotor, at one end, the bearings of the piston motor can be used to support the impact crusher rotor. Accordingly, fewer sets of bearings are required, in addition to the bearings of the piston motor, to support the rotor. This saves the cost of providing a additional bearing sets.

According to a second aspect of the present disclosure, a rotor positioning device for an impact crusher is provided, the impact crusher comprising a frame defining a crushing chamber, a rotor provided with at least one hammer and at least one impact apron plate, the rotor positioning device being configured to adjust a rotational position of the rotor, wherein the rotor positioning device comprises a piston motor configured to be coupled to said rotor and having:
a cylinder block comprising a plurality of cylinders;
a plurality of pistons, a respective piston being slidably mounted in a respective cylinder; and
a surface against which the pistons are configured to exert a force;

wherein the cylinder block and the surface are arranged for relative rotation, and wherein the cylinder block or the surface is configured to be operatively coupled to the rotor when in use, such that relative rotation of the cylinder block and the surface causes rotation of the rotor; the rotor positioning device being operable in two modes, wherein:
in the first mode, the piston motor is configured to actuate the pistons in a predetermined sequence such that the pistons cooperate with the surface to generate torque, thereby causing relative rotation of the cylinder block and the surface, which, in use, causes rotation of the rotor, and
in the second mode, the piston motor is configured to arrange the pistons and/or the surface such that, in use, free rotation of the rotor is permitted.

It will be appreciated that the optional features described above and herein may be applicable to any aspect of disclosure. All combinations contemplated will not be explicitly recited here for the sake of brevity.

### BRIEF DESCRIPTION OF THE DRAWINGS

Embodiments of this disclosure will now be described with reference to the accompanying drawings, in which:

FIG. 1 is a schematic diagram of a first embodiment of an impact crusher disclosed herein;

FIG. 2 is a close up view of the rotor positioning device of the impact crusher of FIG. 1;

FIG. 3 is a partial cross sectional view of the rotor positioning device of the impact crusher of FIG. 1;

FIG. 4 is a cross sectional view of the rotor positioning device of the impact crusher of FIG. 1;

FIG. 5a is a cross sectional view of a radial piston motor of the rotor positioning device in accordance with FIG. 1, wherein the radial piston motor is in the second mode of operation;

FIG. 5b is a cross sectional view of the radial piston motor of FIG. 5a, wherein the motor is in the first mode of operation;

FIG. 6 is a schematic diagram illustrating the hydraulic circuit of the rotor positioning device; and

FIG. 7 is a cross sectional view of a second embodiment of an impact crusher having a rotor positioning device.

### DETAILED DESCRIPTION OF EMBODIMENT(S)

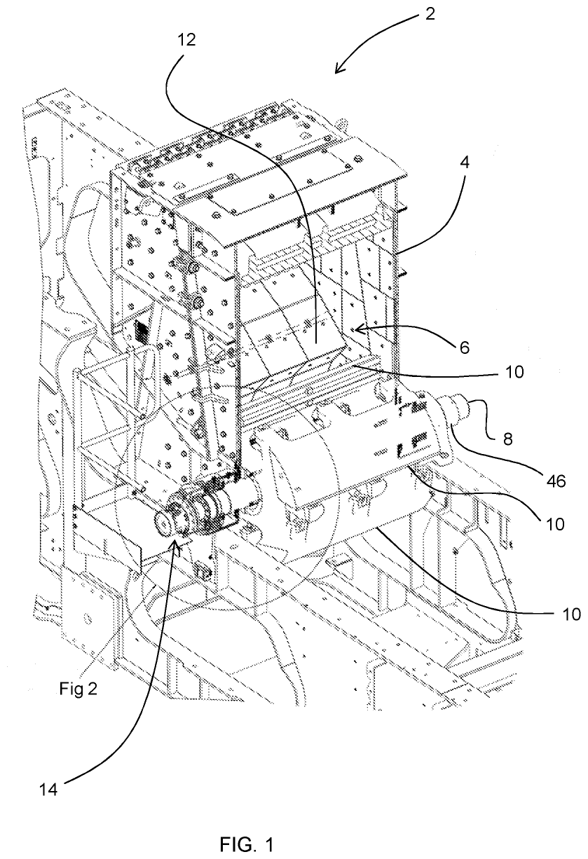

With reference to FIG. 1, an impact crusher is indicated generally at 2 and includes a frame 4 defining a crushing chamber 6. Material to be crushed enters the crushing chamber 6 through an inlet 12 and leaves the crushing chamber 6 through a dispensing aperture (not shown).

The impact crusher 2 also has a rotor 8 having a series of hammers 10. For example, in the embodiment illustrated in FIG. 1, the rotor has four hammers 10. The impact crusher 2 also has at least one impact apron plate (not shown).

The impact crusher 2 has a rotor positioning device indicated generally at 14 and configured to adjust a rotational position of the rotor 8.

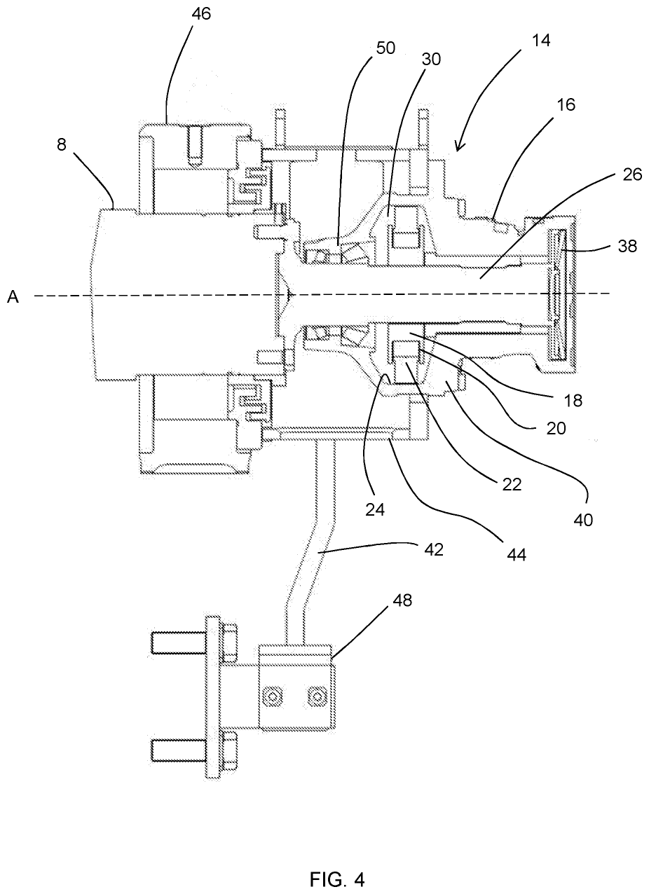

With reference to FIGS. 3 and 4, the rotor positioning device 14 includes a piston motor 16 coupled to the rotor 8. In the embodiment of FIGS. 3-5, the piston motor is a radial piston motor 16. This is also known as a freewheeling radial piston motor.

The piston motor 16 has a cylinder block 18 having a plurality of cylinders 20. A plurality of pistons 22 are located in the cylinder block 18, a respective piston 22 being slideably mounted in a respective cylinder 20. The piston motor 16 also includes a surface 24 against which the pistons 22 are configured to exert a force. The cylinder block 18 and the surface 24 are arranged for relative rotation.

In the embodiment of FIGS. 3-5, the cylinder block 18 is operatively coupled to the rotor 8, such that relative rotation of the cylinder block 18 and the surface 24 causes rotation of the rotor 8.

In alternative embodiments, the surface 24 is operatively coupled to the rotor 8. In other words, the surface 24 is provided by a component which is operatively coupled to the rotor 8. In such embodiments, relative rotation of the surface 24 (or the component comprising the surface 24) and the cylinder block 18 causes rotation of the rotor 8.

In the embodiment illustrated in FIG. 4, the cylinder block 18 is fixed for rotation with a motor shaft 26, which is in turn fixed for rotation with the rotor 8 of the impact crusher 2.

The rotor positioning device 14 is operable in two modes. In the first mode, the piston motor 16 is configured to actuate the pistons 22 in a predetermined sequence. This causes the pistons 22 to co-operate with the surface 24 to generate torque and causing relative rotation of the cylinder block 18 and the surface 22. This causes rotation of the rotor 8. This mode can be thought of as a high torque mode.

In the second mode of operation, the piston motor 16 is configured to position the pistons 22 so that free rotation of the rotor 8 is permitted, for example in normal use of the impact crusher. This will be described in further detail below.

The impact crusher 2 further has a drive motor (not shown) which is separate from the piston motor 16. The drive motor is configured to drive the rotor 8 when the impact crusher 2 is in use.

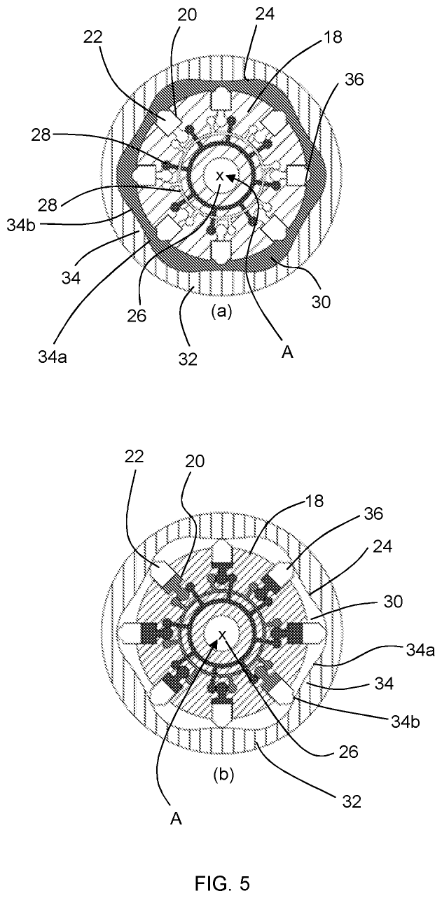

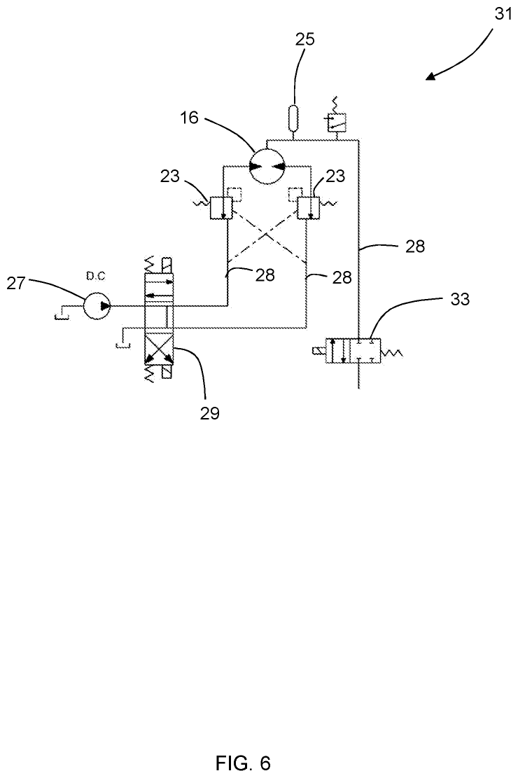

In the embodiment illustrated in FIG. 5, the radial piston motor is a hydraulic motor. The cylinders 20 of the cylinder block 18 are coupled to hydraulic fluid lines 28. In the first mode of operation, hydraulic fluid is forced under a piston 22 from the hydraulic fluid lines 28, which causes the piston 22 to be pushed out of the cylinder block 18 towards the surface 24. The piston motor 16 is configured to actuate the pistons 22 in a predetermined sequence to engage the surface 24 and exert force against the surface 24. This is illustrated in FIG. 5b.

In the second mode of operation, the piston motor 16 is configured to retract the plurality of pistons 22 away from the surface 24 such that the plurality of pistons 22 disengage the surface 24.

A cavity 30 is defined between the surface 24 and an outer surface of the cylinder block 18 and pistons 22. In the second mode of operation, the piston motor 16 is configured to pressurise the cavity 30, e.g. using hydraulic pressure, which causes the pistons 22 to retract into the cylinder block 18, such that the pistons 22 are no longer in contact with the surface 24. This allows the motor shaft 26 of the radial piston motor to be rotated with the impact crusher rotor 8 freely, without any hydraulic fluid flow in or out of the hydraulic fluid lines 28. If the pistons were not retracted into the cylinder block while the rotor is driven during a crushing operation, losses would be incurred due to heat generation and wasted power, for example, due to friction caused by movement of the pistons and movement of fluid in the fluid lines. In this case, the piston motor would effectively be driven as a pump and, even if the resulting flow is simply circulated around the system, this flow would result in wasted power and creation of heat. Consequently, by retracting the pistons, these losses are avoided, and wear of the piston motor during normal operation of the impact crusher is reduced.

With further reference to FIG. 5, the radial piston motor 16 is arranged such that the cylinders 20 are radially disposed in the cylinder block 18, with respect to an axis of rotation of the rotor A.

In some embodiments, the piston motor 16 has a component comprising the surface 24, which is operatively coupled to the rotor 8 such that rotation of the component comprising the surface 24 causes rotation of the rotor 8.

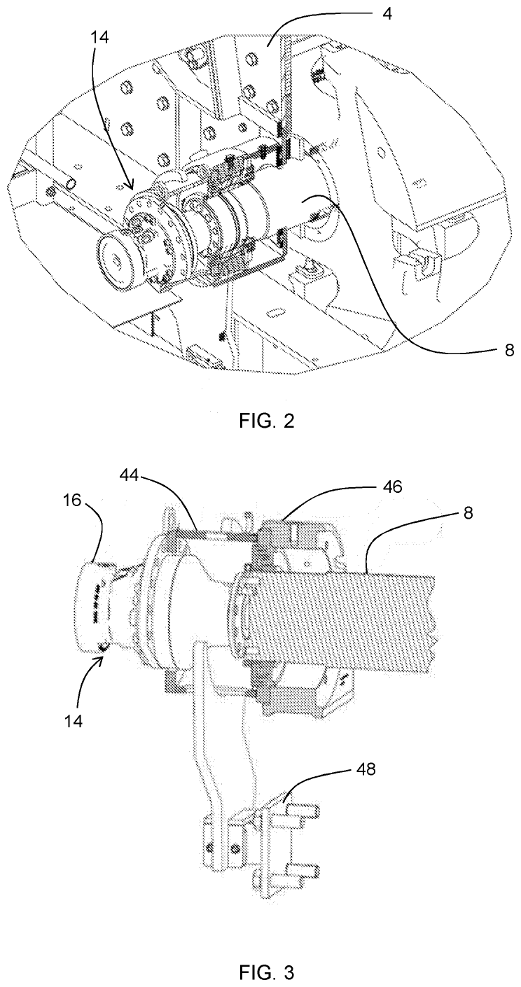

In the embodiment illustrated in FIGS. 1-5, the component comprising the surface is a cam ring 32, wherein the surface 24 is a cam surface of the cam ring 32. The cam surface 24 has a plurality of lobes 34, each of which having a rising ramp 34a and a falling ramp 34b with respect to the direction of rotation of the rotor. In the embodiment illustrated in FIG. 5, the rising and falling ramps 34a, 34b are indicated with respect to clockwise rotation of the cylinder block 18. It will be appreciated that the rotor could turn in either a clockwise or anti-clockwise direction, depending on how the pistons are actuated. Each of the pistons 22 has a cam follower 36 or roller having an outer surface which is designed to roll or slide against the cam surface 24 of the cam ring 32.

It will be appreciated that the cam ring 32 is co-axial with the axis of rotation A.

In the embodiment illustrated in FIG. 5, the cam ring includes an internal cam surface 24 which encircles the cylinder block 18. In this embodiment, the pistons 22 are actuated radially outwards to engage the internal cam surface 24. In alternative embodiments, the cam ring may have an external cam surface which is encircled by the cylinder block. In such embodiments, the pistons may be actuated radially inwards to engage the cam surface.

In some embodiments, the radial piston motor 16 is operable in three modes. In the third mode, the radial piston motor 16 is arranged to actuate one or more of the pistons 22 to exert a force against the surface 24. This force is such that relative rotation of the cylinder block 18 and the surface 24 is inhibited or prevented, thereby inhibiting or preventing rotation of the rotor 8. In this way, the radial piston motor 16 acts as a brake to prevent rotation of the rotor 8.

In addition or alternatively, the rotor positioning device comprises a separate brake component 38, which is configured to act on the motor shaft 26 of the radial piston motor. When the brake 38 is applied, rotation of the motor shaft 26, and hence rotation of the rotor 8, is inhibited or prevented. This can be useful in the event of a leak of hydraulic fluid from the hydraulic fluid lines 28 in order to prevent undesired rotation of the rotor 8.

As will be understood by those skilled in the art, the hydraulic lines 28 form part of a hydraulic circuit 31. The radial piston motor 16 has a mechanical timing mechanism (not shown) and the hydraulic circuit includes a directional valve 29 for controlling the flow of fluid in the hydraulic fluid lines 28. In this way, actuation of the pistons 22 in the predetermined sequence can be controlled.

As will be understood by those skilled in the art, the radial piston motor 16 is coupled to an auxiliary pump 27 arranged to pump hydraulic fluid around the motor 16.

The hydraulic circuit 31 also includes load control (or counterbalance or over-centre) valves 23. These load control valves are configured to hold the rotor (i.e. the motor) in a given rotational position to control the rotation of the rotor when the load becomes imbalanced as it turns.

The hydraulic fluid lines 28 also include an accumulator 25 and a hydraulic brake supply 33 for the brake 38. In some embodiments, the accumulator 25 is configured to store pressure in order to maintain the brake 38 in the actuated position until the rotor has come to a stop (e.g. in the case of an emergency stop).

When the motor 16 is operating in the first mode, the mechanical timing mechanism and valve control system is configured to actuate the pistons 22 in the predetermined sequence. This comprises actuating sets of pistons 22 in a predetermined order and at a predetermined relative timing to cause relative rotational movement between the rotor and housing. For example, where there are 8 pistons, sets of 2 pistons may be actuated in a predetermined order and timing. For example, where there are 12 pistons, sets of 3 or 4 pistons may be actuated in a predetermined order and timing. Any suitable timing mechanisms may be used, as will be understood by those skilled in the art.

As can be seen from FIG. 4, the axis of rotation of the rotor A is co-axial with an axis of rotation of the cylinder block 18. Accordingly, rotation of the cylinder block 18 transmits rotation to the rotor 8 via the motor shaft 26.

Again with reference to FIG. 4, the piston motor 16 has a housing 40 and the impact crusher 2 further has a torque arm 42. The torque arm 42 is coupled to the piston motor housing 40 via a mount 44, which mounts the motor 16 to a bearing housing 46 of the impact crusher 2. The torque arm 42 is also coupled to a fixed position e.g. a torque mount 48 or a position on the frame 4 of the impact crusher 2. Accordingly, the torque arm 42 acts to inhibit rotation of the radial piston motor 16 with respect to the frame 4 of the impact crusher 2.

The rotor positioning device comprises a set of bearings 50 arranged to support the motor shaft 26 of the piston motor 16. In the embodiment illustrated in FIG. 4, the impact crusher comprises a set of bearings in bearing housing 46 at each end of the rotor 8. In other words, the rotor is supported at each end by bearings in the bearing housing 46 and the motor shaft 26 is supported by a set of bearings 50. In some embodiments, the rotor 8 of the impact crusher 2 is supported at the end coupled to the radial piston motor 16 by the set of bearings 50 provided by the piston motor 16. At the other end, a set of bearings 46 is provided to support the rotor 8. In other words, fewer sets of bearings 46 are required to support the rotor 8. The set of bearings 50 provided by the piston motor 16 acts as a set of bearings to support the rotor 8 via the motor shaft 26.

When the impact crusher is in use, it may be necessary to alter the rotational position of one or more of the hammers 10. For example, a hammer 10 may need to be repaired or replaced. Additionally or alternatively, the spacing between one of the hammers 10 and one of the impact apron plates 12 may need to be adjusted. For example the minimum spacing between one of the hammers 10 and one of the impact apron plates 12 may need to be calibrated to ensure that the correct size of material is produced by the impact crusher 2.

To adjust the rotational position of the hammer 10, firstly the drive motor is disconnected from the rotor 8 (e.g. by means of a clutch). The piston motor 16 is powered by means of the auxiliary pump and, via the valve control system and mechanical timing mechanism, is operated in the first mode, as shown in FIG. 5b. Hydraulic fluid is pumped into the hydraulic fluid lines 28, thereby causing fluid to enter one or more of the cylinders 20. This pushes the respective piston 22 out of the cylinder block 18 and towards the cam surface 24, such that the cam follower 36 engages the cam surface 24 and exerts a force against that surface 24.

The radial piston motor 16 is configured such that hydraulic fluid enters the cylinders 20 in a predetermined sequence, such that the pistons 22 are actuated (i.e. forced away from the cylinder block 18) in a predetermined order and at a predetermined relative timing. This actuation of the pistons 22 against the cam surface 24 exerts force against the surface 24. The pistons 22 co-operate with the lobed cam surface 24 and thereby generate torque. This causes the cylinder block 18 to rotate about the axis of rotation A. Since the cylinder block 18 is operatively coupled to the rotor 8 via the motor shaft 24, rotation of the cylinder block 18 causes rotation of the rotor 8 and hence rotation of the hammers 10 about the axis of rotation A. This rotation of the rotor 8 is continued until the hammer 10 is in the desired rotational position with respect to the axis of rotation A. This may be determined by eye or by any other suitable sensing means.

When crushing operation of the impact crusher 2 is again required, the radial piston motor is configured to retract the pistons 22 away from the surface 24 to permit free rotation of the motor shaft 26, and hence free rotation of the rotor 8. In other words, freewheeling of the radial piston motor is permitted.

In order to achieve this, the piston motor 16 is switched to its second mode of operation and pressure is applied to the cavity 30 in order to force the pistons 22 back into their respective cylinders 20 of the cylinder block 18. Pressure may be applied to the cavity 30 via hydraulic pressure. This arrangement is shown in FIG. 5a. As can be seen, the pistons 22 no longer contact the surface 24 and so no longer exert a force against that surface. Consequently, when the drive motor is again operated the rotor 8 is free to rotate to perform the crushing operation. As the rotor 8 rotates, the motor shaft 26 also rotates, thereby rotating the cylinder block 18. Typically, such rotation is at high speed, which is required to effectively crush the material input to the impact crusher 2. Since the pistons 22 do not contact the surface 24, such high speed rotation can be achieved without causing excessive wear of the radial piston motor, nor is additional lubrication of the motor 16 required in order to enable the radial piston motor to be rotated at high speed.

It will be appreciated that the radial piston motor 16 does not itself need to be detached from the rotor 8 when high speed rotation of the rotor 8 is required. In contrast, the rotor positioning device 14 (and the radial piston motor 16) can be permanently attached to the impact crusher 2. To alter the radial position of the rotor 8, the radial piston motor 16 can simply be switched between its second mode and its first mode, for example by an operator. Therefore an effective means of adjusting the radial position of an impact crusher motor 8 is provided, which does not require operator personnel to manually attach and remove the rotor positioning device as and when repositioning of the rotor and normal operation of the impact crusher 2 is desired. This is therefore much more simple for operator personnel and saves time and associated cost.

It may be necessary to restrict rotation of the rotor 8, for example to prevent movement of the hammers 10. In this case, the radial piston motor can be switched to its third mode. In this mode one or more of the pistons 22 is actuated to exert a force against the surface 24 and remains locked in that position. Since the surface 24 includes a series of lobes 34, relative rotation of the cylinder block 18 and the surface 24 is prevented. Accordingly, rotation of the rotor 8 is also inhibited.

Alternatively or additionally, actuation of the brake 38 also acts to prevent rotation of the rotor 8 by preventing rotation of the motor shaft 26.

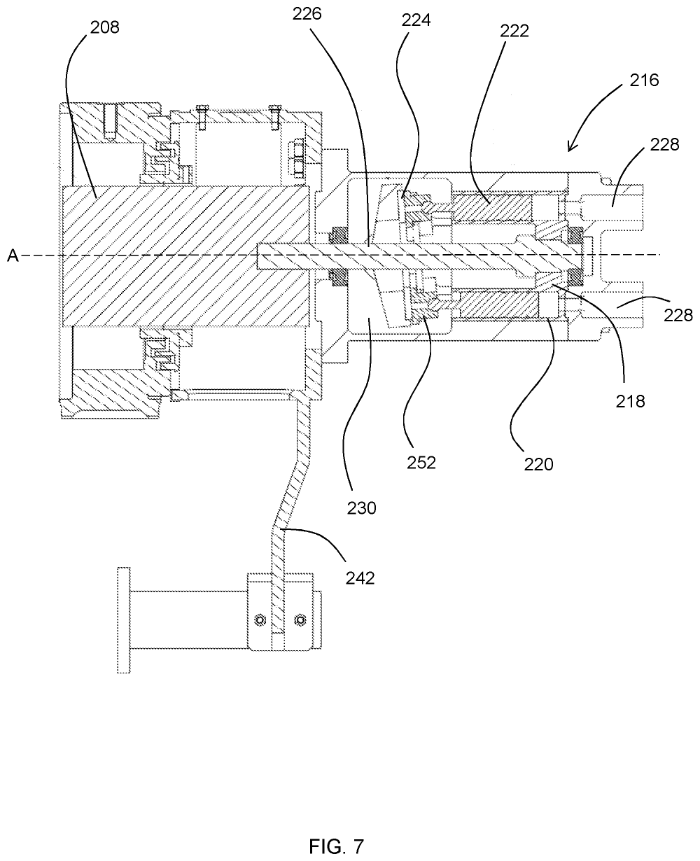

An impact crusher and rotor positioning device in accordance with a second embodiment disclosed herein is illustrated in FIG. 7. Like features are denoted by the same reference numerals as for the first embodiment illustrated in FIGS. 1 to 5 but with the prefix “2”. For the sake of brevity, only the features which are different to those of the first embodiment will be described in detail.

As can be seen from FIG. 7, the piston motor 216 of the second embodiment is an axial piston motor. This has a cylinder block 218 operatively coupled to a motor shaft 226, which is in turn coupled to the rotor 208 of the impact crusher. The cylinder block 218 has a plurality of cylinders 220 which extend in a direction substantially parallel to the axis of rotation A. A plurality of pistons 222 are located in the cylinder block 218, a respective piston 222 being slideably mounted in a respective cylinder 220.

The piston motor 216 also includes a swash plate having a surface 224. The pistons 222 are configured to exert a force against the swash plate surface 224.

As with the first embodiment, the cylinder block 218 and the swash plate surface 224 are arranged for relative rotation about the axis of rotation A.

The surface 224 comprises a planar surface of the swash plate. The planar surface extends in a direction substantially transverse to the axis of rotation A. Further the angle between the planar surface 24 and the axis of rotation A is variable. For example, the angle of the planar surface of the swash plate 24 to the axis of rotation A may be varied between 45° and 135° to the axis of rotation A. In other words, where the axis of rotation A is substantially horizontal, the planar surface of the swash plate 24 is variable between +/−45° to the vertical. For example, the angle of the planar surface of the swash plate 24 to the axis of rotation A may be varied between 60° and 120° to the axis of rotation A. In other words, where the axis of rotation A is substantially horizontal, the planar surface of the swash plate 24 is variable between +/−30° to the vertical. For example, the angle of the planar surface of the swash plate 24 to the axis of rotation A may be varied between 75° and 105° to the axis of rotation A. In other words, where the axis of rotation A is substantially horizontal, the planar surface of the swash plate 24 is variable between +/−15° to the vertical.

Each piston 22 has a slider shoe 252 at one end which is arranged to slide across the surface of the swash plate 24.

The axial piston motor 216 also includes hydraulic fluid lines 228 which are coupled to the cylinders 220 of the cylinder block 218. The axial piston motor 216 is configured such that hydraulic fluid can be forced under the pistons 222 from the hydraulic fluid lines 228, which causes the pistons 222 to be pushed out of the cylinder block 218 to exert force against the surface 224.

In the first mode of operation, the surface 224 of the swash plate is provided at an angle to the axis of rotation A such that the swash plate surface 224 is not perpendicular to the axis of rotation. The axial piston motor 216 is configured to actuate the pistons 222, via the hydraulic fluid lines 228, in the predetermined sequence to exert force against the surface 224. This generates torque and causes relative rotation of the cylinder block 218 and the surface 224, causing rotation of the rotor 208 and radial repositioning of the hammers.

In the second mode of operation, the axial piston motor 216 is configured such that the surface of the swash plate 224 is perpendicular to the axis of rotation A. In this arrangement, the pistons 222 and the surface 224 cannot cooperate in such a way as to generate torque. As will be understood by those skilled in the art, the swash plate must be provided at an acute or obtuse angle to the axis of rotation A in order for torque to be generated.

In some of the embodiments, the pistons 222 are retracted from the surface 224 when the motor 216 is in the second mode of operation. This further reduces the amount of wear on the axial piston motor 216. Similar to the first embodiment, the pistons 222 can be retracted by applying a pressure to the cavity 230, thereby forcing the pistons 222 into their respective cylinders 220 of the cylinder block 218.

Although this disclosure has been made with reference to one or more embodiments, it will be appreciated that various changes or modifications can be made without departing from the scope of the disclosure, as described in the appended claims.

1. An impact crusher, comprising a frame defining a crushing chamber, a rotor provided with at least one hammer, at least one impact apron plate, and a rotor positioning device configured to adjust a rotational position of the rotor, wherein the rotor positioning device comprises a piston motor coupled to the rotor and having:
a cylinder block comprising a plurality of cylinders;
a plurality of pistons, a respective piston being slidably mounted in a respective cylinder; and
a surface against which the pistons are configured to exert a force;
wherein the cylinder block and the surface are arranged for relative rotation, and wherein the cylinder block or the surface is operatively coupled to the rotor, such that relative rotation of the cylinder block and the surface causes rotation of the rotor; the rotor positioning device being operable in first and second modes, wherein:
in the first mode, the piston motor is configured to actuate the pistons in a predetermined sequence such that the pistons cooperate with the surface to generate torque, thereby causing relative rotation of the cylinder block and the surface, causing rotation of the rotor, and
in the second mode, the piston motor is configured to arrange the pistons and/or the surface such that free rotation of the rotor is permitted.

2. The impact crusher according to claim 1, wherein the impact crusher comprises a drive motor, separate from the piston motor, arranged to drive the rotor when the impact crusher is in use.

3. The impact crusher according to claim 1, wherein a cavity is defined between the surface and an outer surface of the cylinder block and pistons disposed therein, wherein in the second mode of operation, the piston motor is configured to pressurize the cavity, thereby applying pressure to the pistons in a direction towards the respective cylinder.

4. The impact crusher according to claim 1, wherein the cylinder block is operatively coupled to the rotor, such that rotation of the cylinder block causes rotation of the rotor.

5. The impact crusher according to claim 1, wherein a component comprising the surface is operatively coupled to the rotor, such that rotation of the component comprising the surface causes rotation of the rotor.

6. The impact crusher according to claim 1, wherein in the second mode of operation, the piston motor is configured to retract the plurality of pistons away from the surface such that the plurality of pistons disengage the surface.

7. The impact crusher according to claim 1, wherein the piston motor comprises a radial piston motor in which the cylinders are radially disposed in the cylinder block, with respect to an axis of rotation of the rotor.

8. The impact crusher according to claim 7, wherein the radial piston motor comprises a cam ring, and wherein the surface comprises a cam surface of the cam ring, the cam surface comprising a plurality of lobes, each lobe having a rising ramp and a falling ramp.

9. The impact crusher according to claim 1, wherein the piston motor comprises an axial piston motor, in which the cylinders extend in a direction substantially parallel to an axis of rotation of the rotor.

10. The impact crusher according to claim 9, wherein the axial piston motor comprises a swash plate, and wherein the surface comprises a planar surface of the swash plate.

11. The impact crusher according to claim 9 wherein each piston is provided at one end with a slider shoe, wherein the slider shoes are configured to slide across the surface of the swash plate.

12. The impact crusher according to claim 1, wherein the piston motor is a hydraulic piston motor and comprises a plurality of conduits for passing hydraulic fluid into the respective cylinders for actuation of the respective pistons.

13. The impact crusher according to claim 1, wherein the piston motor is operable in three modes, wherein in the third mode, the piston motor is configured to actuate at least one of the pistons to exert force against the surface, such that relative rotation of the cylinder block and the surface is inhibited, thereby inhibiting rotation of the rotor.

14. The impact crusher according to claim 1, wherein the rotor positioning device further comprises a brake configured to lock the surface and cylinder block against relative rotation, hence preventing rotation of the rotor.

15. The impact crusher according to claim 1, wherein, in the first mode of operation, actuation of the pistons in the predetermined sequence comprises actuating sets of pistons in a predetermined order and/or at a predetermined relative timing, wherein each set comprises one or more pistons.

16. The impact crusher according to claim 1, wherein the piston motor comprises a mechanical timing mechanism configured to actuate the pistons in the predetermined sequence when the motor is operating in the first mode.

17. The impact crusher according to claim 1, wherein an axis of rotation of the rotor is coaxial with an axis of rotation of the cylinder block and/or an axis of rotation of the surface.

18. The impact crusher according to claim 1, wherein the piston motor comprises a housing and the impact crusher comprises a torque arm coupled to the piston motor housing to inhibit relative rotation between the piston motor housing and the impact crusher frame.

19. The impact crusher according to claim 1, wherein the piston motor comprises a motor shaft coupled to the cylinder block or the surface, and wherein the motor shaft is coupled to the rotor for rotation.

20. A rotor positioning device for an impact crusher, the impact crusher comprising a frame defining a crushing chamber, a rotor provided with at least one hammer and at least one impact apron plate, the rotor positioning device being configured to adjust a rotational position of the rotor of the impact crusher, wherein the rotor positioning device comprises a piston motor configured to be coupled to the rotor and having:
a cylinder block comprising a plurality of cylinders;
a plurality of pistons, a respective piston being slidably mounted in a respective cylinder; and
a surface against which the pistons are configured to exert a force;
wherein the cylinder block and the surface are arranged for relative rotation, and wherein the cylinder block or the surface is configured to be operatively coupled to the rotor when in use, such that relative rotation of the cylinder block and the surface causes rotation of the rotor; the rotor positioning device being operable in first and second modes, wherein:
in the first mode, the piston motor is configured to actuate the pistons in a predetermined sequence such that the pistons cooperate with the surface to generate torque, thereby causing relative rotation of the cylinder block and the surface, which, in use with the impact crusher, causes rotation of the rotor, and
in the second mode, the piston motor is configured to arrange the pistons and/or the surface such that, in use with the impact crusher, free rotation of the rotor is permitted.
